(19) United States
(12) Patent Application Publication
(10) Pub. No.: US 2009/0214897 A1
(43) Pub. Date: Aug. 27, 2009

(54) MAGNETIC STORAGE APPARATUS

(75) Inventor: Kenji Sato, Higashine (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/435,125

(22) Filed: May 4, 2009

Related U.S. Application Data
(63) Continuation of application No. PCT/JP2006/322627, filed on Nov. 14, 2006.

(51) Int. Cl. G11B 5/73

(52) U.S. Cl. 428/848.3; 428/848; 428/848.2

(57) ABSTRACT

A magnetic storage apparatus is provided with a perpendicular magnetic recording medium having a soft magnetic underlayer and a recording layer, and a magnetic head having a medium opposing surface. The soft magnetic underlayer has axes of easy magnetization oriented along a circumferential direction. A return yoke part of a recording element in the head includes return side yokes arranged in a radial direction of a main magnetic pole part on the medium opposing surface, whereby a magnetic flux of a recording magnetic field flows in the radial direction within the soft magnetic underlayer.

### CROSS-REFERENCE TO RELATED APPLICATIONS

This application is a continuation application filed under 35 U.S.C. 111(a) claiming the benefit under 35 U.S.C. 120 and 365(c) of a PCT International Application No. PCT/JP2006/322627 filed on Nov. 14, 2006, in the Japanese Patent Office, the entire contents of which are incorporated herein by reference.

### FIELD

The present invention relates to magnetic storage apparatuses having a perpendicular magnetic recording medium.

### BACKGROUND

Recently, recording densities of magnetic storage apparatus, such as magnetic disk drives, have improved considerably due to low medium noise achieved by magnetic disks and the use of spin-valve reproducing elements for magnetic heads. A surface recording density exceeding 100 Gbit/in² has been achieved by the magnetic disk.

Conventionally, the magnetic storage apparatus uses a magnetic recording medium employing the in-plane recording system. The in-plane recording system can reduce the medium noise by reducing the product (tBr) of remanent magnetization and film thickness and increasing the coercivity (Hc). If the tBr value is reduced considerably, the size of crystal grains of a recording layer becomes small and the remanent magnetization of the recording layer gradually decreases due to the effects of thermal energy, to thereby generate the so-called thermal instability. In addition, because there is a limit to increasing the magnitude of the recording head field, it is believed difficult to further increase the coercivity Hc. Under such circumstances, it is believed difficult to further increase the recording density of the magnetic recording medium employing the in-plane recording system.

Recently, there is active development in the field of magnetic recording media (perpendicular magnetic recording media) employing the perpendicular magnetic recording system, in order to further increase the recording density of the magnetic recording medium. According to the perpendicular magnetic recording system, recording bits recorded on the perpendicular magnetic recording medium are subject to the effects of demagnetization of adjacent recording bits, and for this reason, the higher the recording density, the more stable the magnetization of the remanent magnetization becomes. As a result, the thermal stability is improved according to the perpendicular magnetic recording system.

In the perpendicular magnetic recording medium, a soft magnetic underlayer which is made of a soft magnetic material is provided between a substrate and the recording layer. The magnetic recording and reproduction can be made without providing the soft magnetic underlayer, however, the combination of a single-pole head and the soft magnetic underlayer can greatly increase the magnetic field generated from a recording element at the time of the recording to approximately 1.3 times that of a head conventionally used for the in-plane magnetic recording medium or greater. Consequently, the perpendicular magnetic recording medium can obtain a higher coercivity Hc than the in-plane magnetic recording medium. In addition, because the soft magnetic underlayer sharply draws in the magnetic field generated from the recording element, the magnetic field gradient becomes small and the spreading effect of the recording signal is reduced. Therefore, the perpendicular magnetic recording medium has various advantages over the in-plane magnetic recording medium.

According to the medium structure having the recording layer and the soft magnetic underlayer, there are demands to suppress the problems of a phenomenon referred to as a Wide Adjacent Track ERasure (WATER). The WATER is the phenomenon in which the information of the recording layer is undesirably erased due to the magnetic flux circulating between a return yoke and a shield without passing the magnetic pole and the magnetic flux generated from magnetic domains of the soft magnetic underlayer.

In order to suppress these problems, the head employs a two-layer coil configuration which prevents the circulation of the magnetic flux between the return yoke and the shield. On the other hand, a soft magnetic underlayer having an antiferromagnetic structure made up of two soft magnetic layers which sandwich a Ru layer having a predetermined thickness and have antiparallel magnetizations has been proposed for the perpendicular magnetic recording medium.

Patent Document 1: Japanese Laid-Open Patent Publication No. 6-103554

### SUMMARY

It is an object in one aspect of the present invention to provide a novel and useful magnetic storage apparatus having a perpendicular magnetic recording medium, which can suppress the WATER.

According to one aspect of the present invention, there is provided a magnetic storage apparatus comprising a perpendicular magnetic recording medium having a disk-shaped substrate, a soft magnetic underlayer disposed on the substrate, and a recording layer disposed above the soft magnetic underlayer and having axes of easy magnetization perpendicular to a film surface thereof; and a magnetic head having a medium opposing surface, and a recording element and a reproducing element which are exposed at the medium opposing surface, wherein the soft magnetic underlayer has axes of easy magnetization oriented along a circumferential direction, the recording element has a main magnetic pole part made of a soft magnetic material and applying a recording magnetic field, and a return yoke part made of a soft magnetic material and circulating the recording magnetic field, and the return yoke part includes return side yokes arranged in a radial direction of the main magnetic pole part on the medium opposing surface, whereby a magnetic flux of the recording magnetic field flows in the radial direction within the soft magnetic underlayer.

According to this aspect of the present invention, the magnetic flux of the recording magnetic field flows in the radial direction within the soft magnetic underlayer at the time of the recording, because the side return yokes are arranged in the radial direction of the main magnetic pole part on the medium opposing surface. In addition, since the axes of easy magnetization of the soft magnetic underlayer are oriented in the circumferential direction, the hard axes of magnetization become oriented in the radial direction. Consequently, the high-frequency permeability becomes higher in the radial direction than in the circumferential direction. For this reason, the magnetic flux which switches at the high frequency more easily flows in the radial direction, and the spreading of the recording magnetic field in the in-plane direction within the recording layer is suppressed. Therefore, the WATER can be suppressed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWING

FIG. 1 is a diagram illustrating a part of a magnetic storage apparatus in an embodiment of the present invention;

FIG. 2 is a cross sectional view illustrating a perpendicular magnetic recording medium in the embodiment;

FIG. 3 is a diagram illustrating a portion of a substrate subjected to ion beam texturing;

FIG. 4 is a diagram for explaining an orientation of axes of easy magnetization of a soft magnetic underlayer;

FIG. 5 is a diagram for explaining an ion beam texturing method;

FIG. 6 is a diagram for explaining the ion beam texturing method;

FIG. 7 is a diagram illustrating a magnetic characteristic of the soft magnetic underlayer in an embodiment sample;

FIG. 8 is a diagram illustrating a magnetic characteristic of a soft magnetic underlayer in a comparison example;

FIG. 9 is a perspective view, on an enlarged scale, illustrating a part of a magnetic head in the embodiment;

FIG. 10 is a diagram illustrating a structure of a medium opposing surface of an element part of the magnetic head;

FIG. 11 is a cross sectional view illustrating the element part of the magnetic head and the perpendicular magnetic recording medium;

FIG. 12 is a cross sectional view illustrating the element part of the magnetic head and the perpendicular magnetic recording medium viewed from an air outlet end;

FIG. 13 is a perspective view illustrating another perpendicular magnetic recording medium in the embodiment;

FIG. 14 is a cross sectional view illustrating the other perpendicular magnetic recording medium illustrated in FIG. 13; and

FIG. 15 is a diagram illustrating another structure of the element part of the magnetic head.

### DESCRIPTION OF EMBODIMENTS

Preferred embodiments of the present invention will be described with reference to the accompanying drawings.

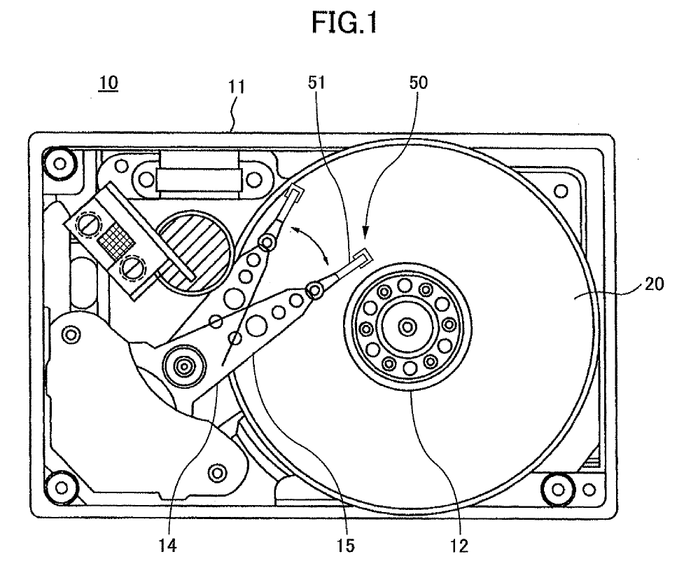

FIG. 1 is a diagram illustrating a part of a magnetic storage apparatus in an embodiment of the present invention. FIG. 1 illustrates a state where a cover for sealing the magnetic storage apparatus has been removed.

As illustrated in FIG. 1, a magnetic storage apparatus 10 includes a housing 11, a perpendicular magnetic recording medium 20 accommodated within the housing 11, a magnetic head 50, an actuator unit 14 which turns the magnetic head 50 in a radial direction by a voice coil motor (VCM, not visible in FIG. 1), and a hub 12. Although hidden by the perpendicular magnetic recording medium 20 and the hub 12 and not visible in FIG. 1, a spindle motor (SPM) is provided under the hub 12 to drive and rotate the perpendicular magnetic recording medium 20. Signals input to and output from the magnetic head 50 are transmitted to and from the magnetic storage apparatus 10 via a signal wiring (56 illustrated in FIG. 9). The signal wiring is connected to a printed circuit board (not illustrated) which is mounted in the housing 11 on an opposite end from the perpendicular magnetic recording medium 20. The printed circuit board is mounted with drive circuits for the VCM and the SPM, a read/write channel circuit for processing recording signals and reproduced signals, a hard disk controller, and the like.

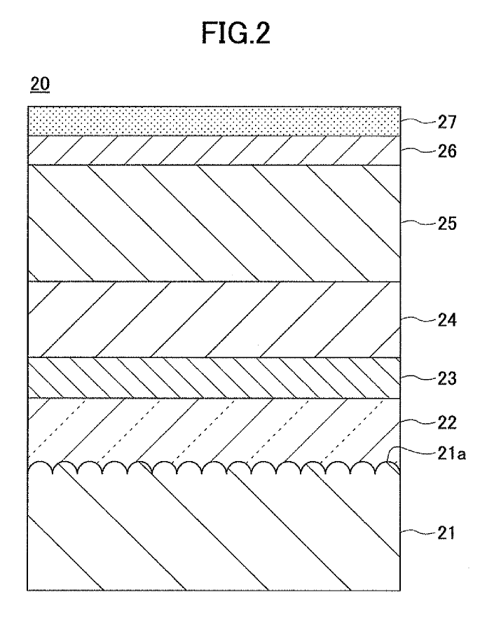

FIG. 2 is a cross sectional view illustrating the perpendicular magnetic recording medium in this embodiment, with the cross section taken along the radial direction.

As illustrated in FIG. 2, the perpendicular magnetic recording medium 20 includes a disk-shaped substrate 21, and a soft magnetic underlayer 22, a seed layer 23, an intermediate layer 24, a recording layer 25, a protection layer 26, and a lubricant layer 27 which are successively stacked on the substrate 21. The surface of the substrate 21 is textured into a texture 21a, and the soft magnetic underlayer 22 is formed on the texture 21a. In FIG. 2, the surface of the seed layer 23 and the like deposited on the texture 21a may inherit the undulations of the texture 21a, but the illustration of such undulations is omitted for the sake of convenience. In this example, the perpendicular magnetic recording medium 20 is a magnetic disk which is based on the disk-shaped substrate 21. In other words, the recording direction is a circumferential direction of the magnetic disk, and a direction perpendicular to the recording direction is the radial direction of the magnetic disk. A more detailed description will now be given of the perpendicular magnetic recording medium 20.

Known substrate materials may be used for the substrate 21. For example, the substrate 21 may be formed by a glass substrate, a NiP-plated aluminum alloy substrate, a silicon substrate, a plastic substrate, a ceramic substrate or, a carbon substrate. From the point of view of forming the preferable texture on the substrate surface as will be described later, the substrate 21 is preferably formed by the glass substrate or the NiP-plated aluminum alloy substrate. The glass substrate may be made of soda glass or borosilicate glass which has been subjected to chemical strengthening, aluminosoda glass, and crystalline glass.

The texture includes a plurality of grooves extending in the circumferential direction, and the axes of easy magnetization of the soft magnetic underlayer 22 are aligned in this circumferential direction. A more detailed description of the texture will be given later.

The soft magnetic underlayer 22 has a film thickness of 10 nm to 2 μm, for example, and is made of an amorphous or microcrystalline soft magnetic material including at least one element selected from a group consisting of Fe, Co, Ni, Al, Si, Ta, Ti, Zr, Hf, V, Nb, C and B. For example, the soft magnetic underlayer 22 is made of CoNbZr, CoTaZr, FeCoB, FeTaC, FeAlSi, CoFeZrTa, NiFe or the like. By using such soft magnetic materials for the soft magnetic underlayer 22, it is possible to suppress saturation of the recording magnetic field and to suppress the side-erase. Of course, the soft magnetic underlayer 22 is not limited to the single-layer structure and may have a multi-layer structure.

For example, the seed layer 23 has a film thickness of 2.0 nm to 10 nm, and is made of an amorphous nonmagnetic material including Ta, W and Mo. The seed layer 23 improves the crystal orientation of the crystal grains of the intermediate layer 24 which is formed on the seed layer 23. Furthermore, the seed layer 23 makes the crystal grain sizes of the intermediate layer 24 uniform, and makes the crystal grain sizes of the recording layer 25 uniform, to thereby reduce the medium noise.

From the point of view of further improving the crystal orientation of the intermediate layer 24 and the crystal orientation of the recording layer 25, the seed layer 23 preferably has a crystalline layer which has the face centered cubic (fcc) crystal structure stacked on the layer of the amorphous nonmagnetic material, although the illustration of the crystalline layer is omitted. The crystalline layer may be made of a material selected from a group consisting of Cu, Ni, NiFe, NiCr and NiCu. The crystalline layer has a preferential growth of the (111) crystal face. The intermediate layer 24 is made of a material having the hexagonal close packed (hcp) crystal structure. For this reason, the (0002) face of the intermediate layer 24 grows preferentially on the (111) crystal face of the crystalline layer, and the (0002) face of the recording layer grows preferentially on the (0002) face of the intermediate layer 24, to thereby improve the crystal orientation of the recording layer 25. Although it is preferable to provide the seed layer 23 as described above, this seed layer 23 may be omitted.

The intermediate layer 24 is made of a nonmagnetic material having the hcp crystal structure. For example, the intermediate layer 24 may be made of Ru or, a nonmagnetic Ru—X alloy having the hcp crystal structure, where X is at least one element selected group a group consisting of Co, Cr, Fe, Ni, Ta, B, Si, Ti and Mn. The (0002) face of the intermediate layer 24 grows preferentially on the seed layer 23 which is made of the amorphous nonmagnetic material. In a case where the seed layer 23 is made up of the layer of the amorphous nonmagnetic material and the crystalline layer having the fcc crystal structure which are stacked in this order, the (0002) face of the intermediate layer 24 grows preferentially and epitaxially on the crystalline layer, to thereby improve the crystallinity of the intermediate layer 24 itself, and the crystallinity and the crystal orientation of the recording layer 25 are improved. In addition, the c-axes of the intermediate layer 24 become aligned perpendicularly to the substrate surface, and the crystal orientation of the intermediate layer 24 is improved. As a result, the intermediate layer 24 improves the crystal orientation of the recording layer 25, and improves the recording and reproducing characteristics of the perpendicular magnetic recording medium 20.

Preferably, the intermediate layer 24 is made of a material selected from a group consisting of Ru, RuCo, RuCoCr, RuCoB, RuCoCrTa, RuSiO₂ and RuTiO₂. The lattice intervals or constants of such materials used for the intermediate layer 24 is approximately the same as the lattice intervals or constants of the recording layer 25. Hence, a satisfactory lattice matching is obtained between the intermediate layer 24 and the recording layer 25, and the dispersion of the orientation of the axes of easy magnetization (c-axes) of the recording layer 25 is reduced, to thereby improve the recording and reproducing characteristics.

As described above, from the point of view of obtaining the satisfactory magnetic characteristic and recording and reproducing characteristics, it is preferably to provide the intermediate layer 24. However, it is not essential to provide the intermediate layer 24, depending on the characteristics required of the perpendicular magnetic recording medium 20.

The recording layer 25 is made of a ferromagnetic material, and includes a ferromagnetic material having the hcp crystal structure, for example. The ferromagnetic material having the hcp crystal structure may be selected from a group consisting of CoCr, CoPt, CoCrTa, CoCrPt and CoCrPt-M, where M is at least one element selected from a group consisting of B, Mo, Nb, Ta, W and Cu. Such ferromagnetic materials used for the recording layer 25 will hereinafter be referred to as recording layer ferromagnetic materials. The recording layer 25 may be formed by a ferromagnetic layer made up solely of the recording layer ferromagnetic material, that is, formed by the so-called continuous layer.

The recording layer 25 may be formed in an atmosphere including oxygen gas when sputtering the recording layer ferromagnetic material, so that the recording layer 25 is formed by a ferromagnetic material including oxygen. Because the oxygen is introduced to the grain boundary part at the interface between the magnetic grains, the thickness of the grain boundary part increases and the magnetic grains are positively isolated from each other. Consequently, the medium noise is reduced, and the Signal-to-Noise Ratio (SNR) is improved. The recording layer 25 in this case has a composition including oxygen (O) in the recording layer ferromagnetic material, and the composition is CoCr—O, CoCrPt—O, CoCrPt—O or CoCrPt-M-O, for example.

The recording layer 25 may be formed by the so-called granular layer which includes magnetic grains made of the recording layer ferromagnetic material and a nonsoluble phase made of nonmagnetic material surrounding the magnetic grains. The magnetic grains have a columnar structure that grows in the direction approximately perpendicular to the substrate surface from the surface of the intermediate layer 24, and the magnetic grains are mutually isolated in the direction parallel (in-plane) to the substrate surface by the nonsoluble phase. The nonsoluble phase is made of a nonmagnetic material that is nonsoluble with respect to the ferromagnetic material forming the magnetic grains or, a nonmagnetic material that does not form a compound. The nonsoluble phase is made of a compound of an element selected from a group consisting of Si, Al, Ta, Zr, Y, Ti and Mg, and at least one element selected from a group consisting of O, N and C. For example, the nonsoluble phase may be formed by an oxide such as SiO₂, Al₂O₃, Ta₂O₅, ZrO₂, Y₂O₃, TiO₂ and MgO, a nitride such as Si₃N₄, AlN, TaN, ZrN, TiN and Mg₃N₂ or, a carbide such as SiC, TaC, ZrC and TiC. Because the magnetic grains are physically isolated from the adjacent magnetic grains by the nonsoluble phase that is made of the nonmagnetic material described above, the magnetic interaction is reduced. As a result, the medium noise is reduced and the SNR is improved.

Among the compositions of the granular layer, the magnetic grains are preferably made of CoCrPt or CoCrPt-M, and the nonsoluble phase is preferably made of the oxide, namely, SiO₂ or TiO₂. According to such a combination forming the composition of the granular layer, the magnetic grains are isolated by the nonsoluble phase in an approximately uniform manner, and satisfactory magnetic characteristic and recording and reproducing characteristics are obtained.

The recording layer 25 may be formed by a ferromagnetic synthetic lattice layer in which thin films of a ferromagnetic element and a nonmagnetic element are alternately stacked a plurality of times. Examples of such a ferromagnetic synthetic lattice layer include a Co/Pd synthetic lattice layer in which a plurality of Co and Pd layers are alternately stacked, and a Co/Pt synthetic lattice layer in which a plurality of Co and Pt layers are alternately stacked. The ferromagnetic synthetic lattice layer has axes or easy magnetization aligned in the direction perpendicular to the film surfaces. Because the ferromagnetic synthetic lattice layer is made of a material having a uniaxial anisotropy constant greater than that of the recording layer ferromagnetic material, it is easy to increase the coercivity. A repetition unit of the Co layer, the Pd layer or the Pt layer in the ferromagnetic synthetic lattice layer may be a single layer or two layers.

The recording layer 25 is not limited to a single-layer structure, and may have a multi-layer structure made up of stacked layers. In the latter case, the stacked layers are formed by ferromagnetic layers including the recording layer ferromagnetic materials having mutually different compositions. In other words, the recording layer 25 is made of a recording layer ferromagnetic material which is a combination of mutually different elements or, made of a recording layer ferromagnetic material which is a combination of identical elements having mutually different element contents. From the point of the suitability for the high recording density, the film thickness of the recording layer 25 is preferably set in a range of 3 nm to 25 nm.

The protection layer 26 is not limited to a particular material. For example, the protection layer 26 is made of a material selected from a group consisting of amorphous carbon, carbon hydride, carbon nitride, and aluminum oxide, and has a film thickness of 0.5 nm to 15 nm.

The lubricant layer 27 is not limited to a particular material. For example, the lubricant layer 27 is made of a lubricant having perfluoroether as the principal chain. The lubricant layer 27 may be provided or, may not be provided, depending on the material used for the protection layer 26.

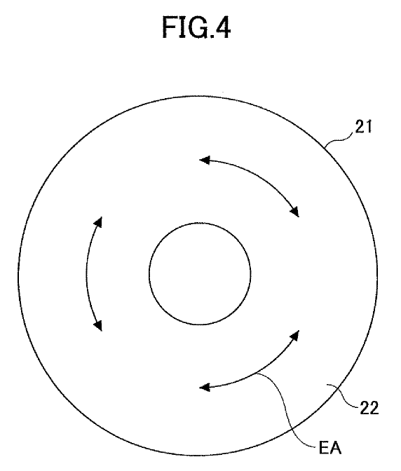

Next, a more detailed description will be given of the texture 21a of the perpendicular magnetic recording medium 20. The texture 21a includes a plurality of grooves extending in the circumferential direction. The texture 21a may be formed by mechanical texturing. The mechanical texturing inserts a polishing agent including diamond particles or alumina particles between the substrate 21 and a pad which presses against the substrate 21, and moves the pad or the substrate 21 relative to each other in order to form polishing impressions or marks on the substrate surface. In this embodiment, the substrate 21 is rotated, for example, in order to form the polishing impressions which extend in the circumferential direction. Hence, as illustrated in FIG. 4 described later, the axes of easy magnetization of the soft magnetic underlayer 22 become aligned in the circumferential direction, and the effects of this orientation will be described later.

The pad or the substrate 21 may be reciprocated in the radial direction so that the direction in which the polishing impressions extend is within several degrees, for example, within 5 degrees, with respect to the circumferential direction. The average pitch of the polishing impressions in the radial direction is preferably set in a range of 1 nm to 100 nm. In addition, the texture 21a may be formed by the so-called ion beam texturing which will be described later.

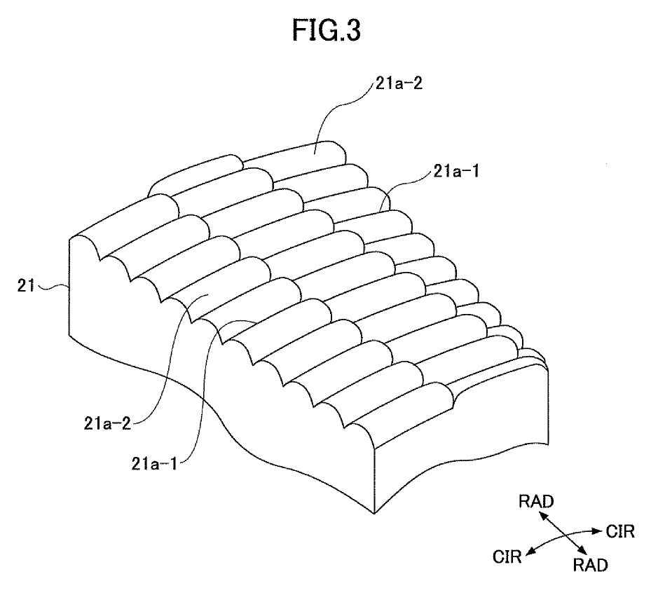

FIG. 3 is a diagram illustrating a portion of the substrate subjected to the ion beam texturing. FIG. 4 is a diagram for explaining the orientation of the axes of easy magnetization of the soft magnetic underlayer. In FIG. 3, an arrow CIR indicates the circumferential direction of the substrate 21, and an arrow RAD indicates the radial direction of the substrate 21.

As may be seen from FIGS. 3 and 4 in conjunction with FIG. 2, the texture 21a formed on the surface of the substrate 21 is formed by irradiating the ion beam on the substrate surface in a predetermined direction from a texture forming apparatus which will be described later, in order to form a plurality of grooves in a self-organizing manner within a region irradiated with the ion beam. The texture 21a includes a plurality of grooves 21a-1 which extend approximately parallel to each other along the circumferential direction (arrow direction CIR illustrated in FIG. 3), and further, the grooves 21a-1 are formed at approximately a predetermined pitch along the radial direction (arrow direction RAD illustrated in FIG. 3). For this reason, as illustrated in FIG. 4, axes EA of easy magnetization of the soft magnetic underlayer 22 become aligned in the circumferential direction by the texture 21a. Hence, by the provision of the texture 21a, the axes EA of easy magnetization of the soft magnetic underlayer 22 become aligned in the circumferential direction. Accordingly, the orientation of the axes EA of easy magnetization in the circumferential direction is improved by the grooves 21a-1 of the texture 21a, and the anisotropic field Hk is increased, to thereby reduce the high-frequency permeability in the circumferential direction on one hand and improve the high-frequency permeability in the radial direction. As will be described later, the magnetic flux of the recording magnetic field flows in the radial direction within the soft magnetic underlayer 22, that is, along a direction having a high permeability, depending on the arrangement of the return yoke part of the recording element. Hence, the spreading of the recording magnetic field in the direction parallel to the film surface is suppressed, from the main magnetic pole to the soft magnetic underlayer 22 via the recording layer 25, and as a result, the WATER described above is suppressed.

The groove 21a-1 of the texture 21a formed by the ion beam is defined by protruding stripes 21a-2 which are elongated in the circumferential direction. The protruding stripes 21a-2 are arranged approximately along the circumferential direction, but are not necessarily aligned linearly along the circumferential direction, and may be slightly deviated in the radial direction. When the protruding stripes 21a-2 are arranged in this manner, the grooves 21a-1 are not aligned linearly along the circumferential direction but a large portion of each groove 21a-1 is formed along the circumferential direction. For this reason, the deviation of the axes EA of easy magnetization of the soft magnetic underlayer 22 from the circumferential direction becomes small. In other words, the angular dispersion of the axes EA of easy magnetization of the soft magnetic underlayer 22 can be made smaller than that of the mechanical texturing, and thus, it is possible to further reduce the WATER.

As will be described hereunder, in the specification and claims, “an approximately constant pitch” or “approximately a predetermined pitch” includes cases where a region in which the pitch of the grooves in the circumferential direction is not constant is locally formed on the perpendicular magnetic recording medium. Such cases include a case where the adjacent grooves themselves overlap each other or, a concave part is formed spanning a plurality of grooves.

From the point of view of applying a satisfactory magnetic anisotropy, the pitch of the grooves 21a-1 of the texture 21a in the circumferential direction is preferably in a range of 1 nm to 100 nm. In other words, from the point of view of applying a satisfactory magnetic anisotropy, the number of grooves 21a-1 per 1 μm in the circumferential direction is preferably set in a range of 1000 to 10 in the texture 21a.

Preferably, the average groove depth of the grooves 21a-1 is set in a range of 0.3 nm to 5.0 nm (and more preferably 0.3 nm to 2.0 nm). If the average groove depth is less than 0.3 nm, the orientation of the recording layer 25 in the arrow direction RAD becomes insufficient. On the other hand, if the average groove depth exceeds 5.0 nm, the surface roughness of the perpendicular magnetic recording medium 20 deteriorates and a head crash occurs more easily. The depth of the groove 21a-1 can be measured using an Atomic Force Microscope (AFM), by measuring a cross sectional shape of the groove 21a-1 in a direction perpendicular to the direction in which the groove 21a-1 extends, and measuring a length of a normal from a deepest position of a valley in the cross sectional shape to a straight line connecting two adjacent peaks sandwiching the valley. The average groove depth is an average value of the measured values of approximately 40 grooves 21a-1, for example.

The soft magnetic underlayer 22 may have a single-layer structure, because the anisotropic field Hk increases due to the texture 21a. In this case, the structure becomes simple compared to the case where the soft magnetic underlayer 22 has a stacked ferri structure, and the production cost of the perpendicular magnetic recording medium 20 can be reduced. Further, it is unnecessary in this case to use Ru which is expensive.

Instead of forming the texture 21a on the surface of the substrate 21, it is possible to form a dielectric layer between the substrate 21 and the soft magnetic underlayer 22, and form the texture on the surface of the dielectric layer. The illustration of such a dielectric layer will be omitted. The dielectric layer may be made of a material selected from a group consisting of oxides, nitride and carbides of metal elements, glass, and ceramic. For example, silicon dioxide, silicon nitride or silicon carbide may be used for the dielectric layer. By providing the dielectric layer with the texture, it is possible to obtain effects similar to those obtainable by the texture 21a on the substrate surface.

Next, a description will be given of a method of producing the perpendicular magnetic recording medium 20.

First, the surface of the substrate 21 is cleaned and dried. Thereafter, the texture 21a having the plurality of grooves 21a-1 extending in the circumferential direction is formed on the surface of the substrate 21 using the texture forming apparatus. The texture 21a may be formed by mechanical texturing or, by ion beam texturing using the ion beam. A more detailed description will now be given of the texture forming process using the ion beam.

A texture forming apparatus 30 has a vacuum chamber 44. A substrate holder 31 on which the substrate 21 is set, and a rotary drive part 32 for rotating the substrate 21 via the substrate holder 31 about a rotary shaft perpendicular to a principal plane of the substrate holder 31, are provided within the vacuum chamber 44. The texture forming apparatus 30 further has an exhaust system 45 which includes a rotary pump, a rotodynamic pump or the like for maintaining a vacuum atmosphere within the vacuum chamber 44 by exhausting the inside of the vacuum chamber 44.

An ion gum 35 for irradiating an ion beam 41 on the substrate 21, is provided above the substrate 21. For example, a Kaufman type ion gun, a follow cathode type ion gun, an Electron Cyclotron Resonance (ECR) type ion gun or the like may be used for the ion gun 35. The use of the Kaufman type ion gun is preferable in that an ion beam having a large beam diameter on the order of several cm to several tens of cm can be emitted. The Kaufman type ion gun is also preferable in that the ion beam 41 emitted therefrom has a satisfactory linearity.

The ion gun 35 includes a hot cathode 36, a hollow cylindrical magnetron anode 38, a coil 39 for applying a magnetic field in a direction of a center axis of the magnetron anode 38, a shielding electrode 37, and an accelerating electrode 40 for drawing out and accelerating the ionized gas. The shielding electrode 37 and the accelerating electrode 40 respectively have a plurality of apertures 37a and 40a which confront each other and have a diameter of several hundred μm. A power supply unit (not illustrated) is connected to each of the hot cathode 36, the magnetron anode 38 and the accelerating electrode 40. The ion gun 35 may be provided with a neutralizer which emits hot electrons into the ion beam which is accelerated by the accelerating electrode 40. The hot electrons suppress charging of a substrate surface 21-1 of the substrate 21 and the shielding plate 42 which are irradiated by the ion beam 41.

A description will be given of the operation of the ion gun 35. First, the electrons emitted from the hot cathode 36 undergo trochoid motion and are trapped within the hollow cylindrical magnetron anode 38. The trapped electrons collide with the supplied gas, and ionizes the gas to generate gas ions (positive ions). The gas ions are drawn out via the apertures 40a by a negative accelerating voltage applied to the accelerating electrode 40, and are accelerated in order to form the ion beam 41. The ion beam 41 irradiates the substrate 21 by traveling in a predetermined irradiating direction with respect to the substrate surface 21-1.

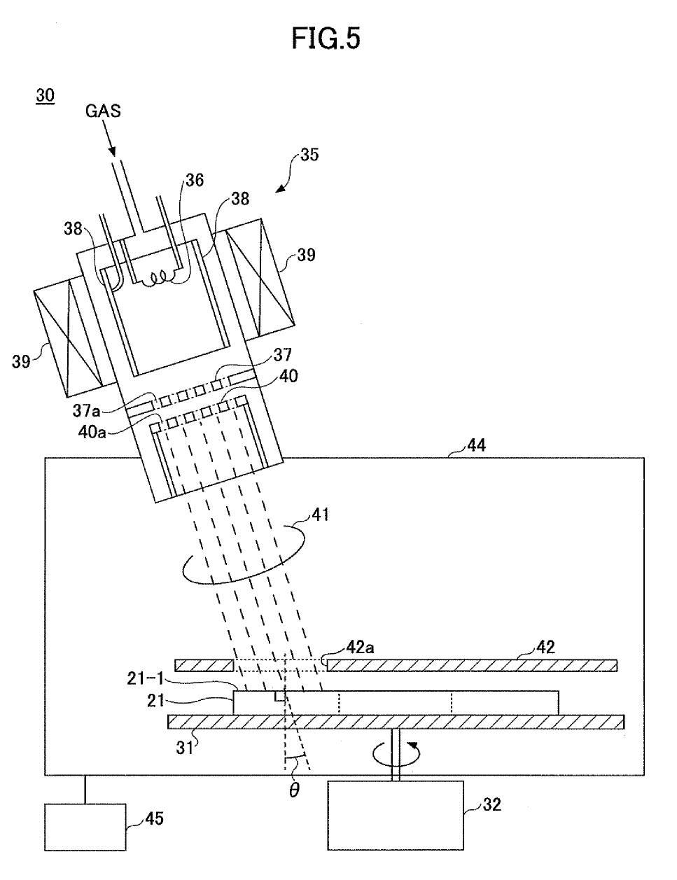

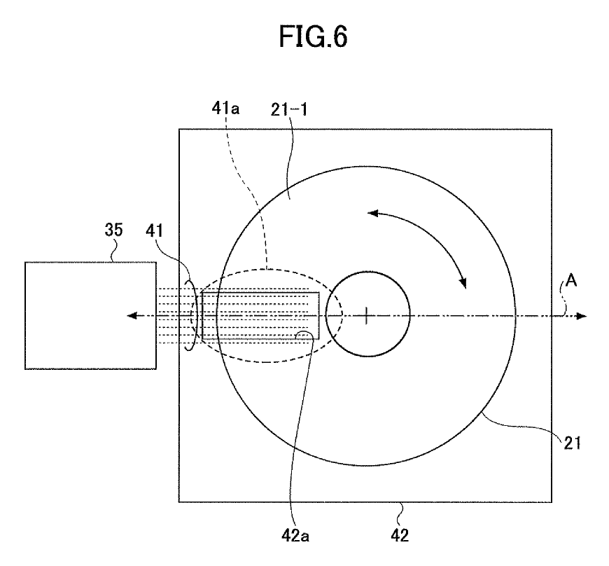

The irradiating direction of the ion beam 41 is set parallel to the radial direction of the substrate 21 at an irradiating position (immediately under the windows 42a). In addition, the irradiating direction of the ion beam 41 is set to a direction inclined by an irradiating angle θ towards the radial direction of the substrate 21 from a direction perpendicular to the substrate surface 21-1, as illustrated in FIG. 5. In other words, the irradiating direction of the ion beam 41 is the direction inclined by the irradiating angle θ from the direction perpendicular to the substrate surface 21-1, within a plane which is formed by the radial direction of the substrate and the direction perpendicular to the substrate surface 21-1. By setting the irradiating direction and irradiating the ion beam 41 in this manner, a plurality of fine grooves 21a-1 are formed in the substrate surface 21-1 along the circumferential direction in a self-organizing manner, and these grooves 21a-1 are formed at approximately a predetermined pitch in the radial direction.

The forming of the grooves 21a-1 in the self-organizing manner refers to the automatic forming of the grooves 21a-1 which are extremely fine compared to the cross sectional dimension of the ion beam 41. In other words, instead of forming the individual grooves 21a-1 on the substrate surface 21-1 by stopping the ion beam, a plurality of grooves 21a-1 are formed within the region irradiated by the ion beam 41.

The irradiating angle θ of the ion beam 41 is preferably set in a range of 45 degrees to 70 degrees. If the irradiating angle θ is less than 45 degrees or, exceeds 70 degrees, it becomes difficult to form grooves having a sufficient depth. From the point of view of forming deeper grooves, the irradiating angle θ are more preferably set in a range of 55 degrees to 65 degrees.

An inert gas, such as Ar gas, Kr gas and Xe gas, may be used for the ion beam 41. In addition, a mixture of at least two kinds of gases, from among Ar gas, Kr gas and Xe gas, may be used for the ion beam 41. From the point of view of efficiently forming grooves 21a-1 that are deep and uniform, it is preferable to use the Kr gas or the Xe gas for the ion beam 41.

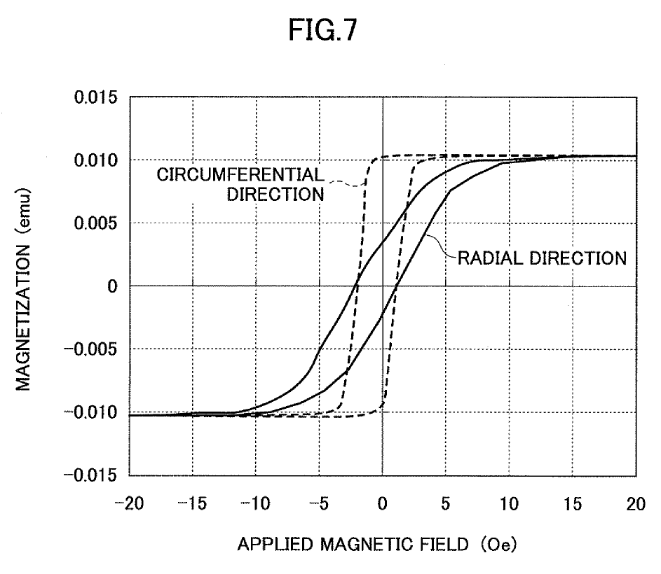

An amount of gas supplied to the ion gun 35 is preferably set in a range of 2 sccm to 20 sccm, for example. In addition, the accelerating voltage of the ion beam 41 (voltage applied to the accelerating electrode 40 illustrated in FIG. 7) is preferably set to 0.5 kV to 1.0 kV. The lower the accelerating voltage, the narrower the groove pitch, and the tendency is for the number of grooves per unit length, in the direction perpendicular to the direction in which the grooves 21a-1 extend, to increase. Accordingly, by appropriately selecting the accelerating voltage depending on the average grain diameter or the like of the crystal grains of the recording layer 25, it is possible to obtain an appropriate orientation for the recording layer 25 in the circumferential direction. Moreover, an ion beam current may be appropriately selected in a range of 10 mA to 500 mA, depending on a processing time.

The substrate 21 may be rotated by a rotary drive means (not illustrated) while irradiating the ion beam 41 from the ion gun 35 on the substrate 21. The substrate 21 may be rotated about a center axis which passes a center of the substrate 21 and is perpendicular to the substrate surface 21-1, in one of the two rotating directions or, in both rotating directions by combining rotations in the two rotating directions. The rotational speed of the substrate 21 is set on the order of 15 revolutions per minute. Although illustration thereof will be omitted, the texture forming apparatus may be provided with a plurality of ion guns. In this case, the texture 21a may be formed on the substrate surface 21-1 by a plurality of ion beams which simultaneously irradiate the substrate 21. When using the plurality of ion guns, the substrate 21 may or may not be rotated when forming the texture 21a.

In order to limit the range on the substrate 11 where the ion beam 41 is irradiated, it is possible to provide the shielding plate 42 between the accelerating electrode 40 and the substrate 21. The windows 42a in the shielding plate 42 preferably have a slit shape which is elongated in the radial direction of the substrate 21. By providing the windows 42a, it is possible to limit the irradiating range of the ion beam 41 which spreads in the circumferential direction. By limiting the irradiating range of the ion beam 41 in the circumferential direction, the grooves 21a-1 are formed along the radial direction and the deviation of the grooves 21a-1 from the radial direction is small. When the texture 21 has such grooves 21a-1, the orientation of the recording layer 25 in the circumferential direction improves. The ion beam 41 may be irradiated while rotating the substrate 21 as described above, when using the shielding plate 42 having such windows 42a.

Next, in the process after the texture forming process, a wet cleaning, such as a scrub cleaning, is performed on the surface of the substrate 21 having the texture 21a, using pure water or a combination of a surface active agent and pure water. Particles of the substrate material and the like generated during the texture forming process can be removed from the surface of the substrate 21 by performing the wet cleaning. As a result, it is possible to avoid projections or the like from being generated on the surface of the perpendicular magnetic recording medium 20 that is formed due to the residual particles remaining on the substrate surface 21-1. Of course, an ultrasonic cleaning may be performed in place of the scrub cleaning, and it is possible to combine the scrub cleaning and the ultrasonic cleaning. Other known cleaning methods may be employed to clean the substrate surface 21-1. In addition, it is possible to perform a known dry cleaning in place of the wet cleaning, depending on the amount of particles of the substrate material adhered on the substrate surface 21-1.

Next, the substrate 21 is set within a deposition chamber which is not illustrated. The substrate 21 may be heated in vacuum in order to dry the substrate surface 21-1, however, the substrate 21 is cooled before the soft magnetic underlayer 22 is deposited on the substrate 21.

Next, the soft magnetic underlayer 22 is deposited on the substrate 21 having the texture 21a formed thereon, within the deposition chamber, by electroless plating, electroplating, sputtering, vacuum deposition or the like.

Then, the seed layer 23 is formed on the soft magnetic underlayer 22 in a sputtering apparatus using a sputtering target made of one of the materials described above. Preferably, an ultra-high-vacuum sputtering apparatus capable of exhausting to 10⁻⁷ Pa is used for the sputtering apparatus. More particularly, the seed layer 23 is formed by DC magnetron sputtering in an inert gas atmosphere, such as an Ar gas atmosphere, at a pressure of 0.4 Pa and a power of 0.5 kW, for example. The substrate 21 is preferably not heated when forming the seed layer 23. In this case, it is possible to suppress crystallization of the soft magnetic underlayer 22 or enlarging of the microcrystals in the soft magnetic underlayer 22. However, it is of course possible to heat the substrate 21 to such an extent, such as a temperature of 150° C. or less, so that crystallization of the soft magnetic underlayer 22 or enlarging of the microcrystals of the soft magnetic underlayer 22 will not occur. The temperature condition for the substrate 21 during the forming of the soft magnetic underlayer 22 is similar to those during the forming of the intermediate layer 24 and the recording layer 26.

Next, the intermediate layer 24 and the recording layer 25 are successively formed on the seed layer 23, using sputtering targets made of the materials described above. The conditions under which the intermediate layer 24 and the recording layer 25 are formed are similar to the conditions under which the seed layer 23 is formed.

The recording layer 25 may be formed in an atmosphere in which oxygen gas or nitrogen gas is added to the inert gas or, in an oxygen gas atmosphere or, in a nitrogen gas atmosphere, instead of using the inert gas atmosphere described above. In this case, the isolation of the magnetic grains of the recording layer 25 is improved, to thereby reduce the medium noise and improve the SNR.

If the recording layer 25 has the granular structure, a sputtering using a sputtering target made of the ferromagnetic material described above and a sputtering using a sputtering target made of the nonmagnetic material in the nonsoluble phase are performed simultaneously in the inert gas atmosphere. In this case, oxygen gas, nitrogen gas or carbon dioxide may be added to the inert gas or, the simultaneous sputtering may be performed in the oxygen gas atmosphere, the nitrogen gas atmosphere or the carbon dioxide atmosphere, if the nonmagnetic material is an oxide, nitride or carbide. It is possible in this case to form a satisfactory recording layer 25 by suppressing the content of oxygen, nitrogen or carbon in the nonsoluble phase from decreasing below the stoichiometric composition. As a result, satisfactory durability and corrosion resistance of the perpendicular magnetic recording medium 20 are obtained. Instead of using two sputtering targets, it is of course possible to use a single sputtering target which is made of a composite material including the ferromagnetic material and the nonmagnetic material. In this case, it is possible to easily control the mole ratio between the magnetic grains and the nonsoluble phase in the recording layer 25.

Next, the protection layer 26 is formed on the recording layer 25 by sputtering, Chemical Vapor Deposition (CVD), Filtered Cathodic Arc (FCA) or the like. In addition, the lubricant layer 28 is coated on the surface of the protection layer 26 by lifting, spin-coating, dipping or the like. By the processes described above, the perpendicular magnetic recording medium 20 of the first embodiment is formed.

In the example described above, the process of forming the seed layer 23 up to the process of forming the recording layer 25 are performed by DC magnetron sputtering. However, it is of course possible to use other sputtering methods (for example, RF sputtering) and vacuum deposition methods.

In addition, from the point of view of keeping the surface of the substrate 21 or each of the formed layers clean, it is preferable that the process of forming the seed layer 23 up to the process of forming the protection layer 26 are performed in vacuum or a deposition environment.

Next, in order to confirm the effects of orienting the axes of easy magnetization of the soft magnetic layer 22 by the texture 21a, a substrate surface of a sample of this embodiment (hereinafter also referred to as an embodiment sample) was subjected to a mechanical texturing and a soft magnetic underlayer was formed on the mechanically textured substrate surface. In addition, a sample of a comparison example (hereinafter also referred to as a comparison sample) was formed similarly to the embodiment sample, but without the mechanical texturing.

The embodiment sample was formed in the following manner. The surface of a disk-shaped glass substrate having an outer diameter of 65 mm was cleaned and dried, and polishing impression or marks were formed in the circumferential direction on the surface of the glass substrate by a texture forming apparatus. The average surface roughness of the substrate surface after the texture forming process and measured by an AFM was 0.45 nm. The glass substrate having the texture was set within a vacuum chamber, and after exhausting the inside of the vacuum chamber to a pressure of 1.0×10⁻⁵ PA, a soft magnetic underlayer was formed by DC magnetron sputtering to a thickness of 200 nm in an Ar gas environment at a pressure of 6.7×10⁻¹ Pa using a CO₈₇Zr₅Nb₈ (composition indicated by percentage) sputtering target, without heating the glass substrate.

Hysteresis curves of the embodiment sample and the comparison sample were measured using a Vibration Sample Magnetometer (VSM) by applying a magnetic field in each of the radial direction and the circumferential direction within the in-plane direction of the samples.

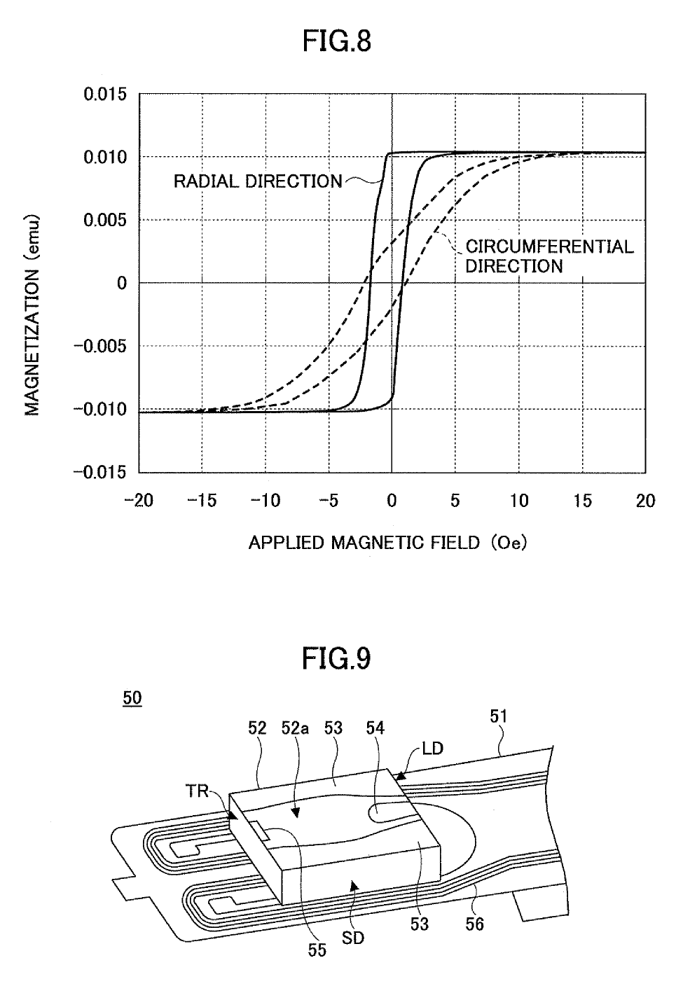

FIG. 7 is a diagram illustrating a magnetic characteristic of the soft magnetic underlayer in the embodiment sample, and FIG. 8 is a diagram illustrating a magnetic characteristic of the soft magnetic underlayer in the comparison example. The curves indicated by “radial direction” and “circumferential direction” in FIGS. 7 and 8 represent the hysteresis curves that were measured by applying the magnetic field in the radial direction and the circumferential direction, respectively.

In the embodiment sample illustrated in FIG. 7, the hysteresis curve for the circumferential direction is closer to a rectangular shape than the hysteresis curve for the radial direction, and the axes of easy magnetization are aligned in the radial direction. The anisotropic field is approximately 5 Oe when observed from the hysteresis curve for the radial direction. On the other hand, in the embodiment sample illustrated in FIG. 8, the hysteresis curve for the radial direction is closer to a rectangular shape than the hysteresis curve for the circumferential direction, and the axes of easy magnetization are aligned in the radial direction. Accordingly, it was confirmed that the axes of easy magnetization align in the radial direction for the comparison due to the magnetic field distribution of the DC magnetron sputtering, but the axes of easy magnetization align in the circumferential direction for the embodiment sample having the mechanical texture even though the DC magnetron sputtering is performed, and the hard axes of magnetization align in the radial direction. Because the hard axes of magnetization are aligned in the radial direction, the high-frequency permeability in the radial direction becomes higher than that in the circumferential direction, and the magnetic flux of the recording magnetic field more easily flows in the radial direction.

Next, a description will be given of the magnetic head of the magnetic storage apparatus in the embodiment.

FIG. 9 is a perspective view, on an enlarged scale, illustrating a part of the magnetic head in this embodiment.

As illustrated in FIG. 9, the magnetic head 50 has the head slider 52 which is provided on the tip end of the suspension 51, and the signal wiring 56 for transmitting the recording current to an element part 55 and transmitting the reproduced signal from the element part 55. A medium opposing surface 52a (the surface which opposes the perpendicular magnetic recording medium when the magnetic head 50 floats on the perpendicular magnetic recording medium) of the head slider 52 has a center rail 54 located at an air inlet end LD, side rails 53 located near a side part SD and extending from the air inlet end LD to an air outlet end TR, and the element part 55 located in a central portion at the air outlet end TR. The center rail 54 and the side rails 53 receive pressure of the air flow when the perpendicular magnetic recording medium rotates, to thereby generate a floating force which causes the head slider 52 to float from the perpendicular magnetic recording medium.

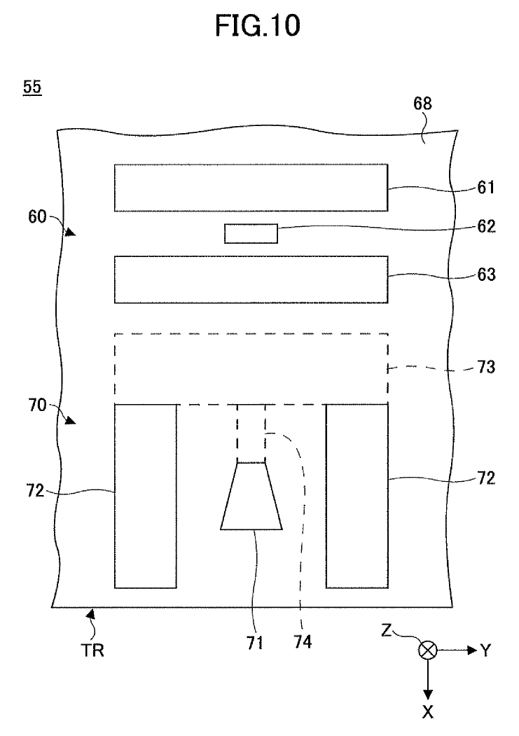

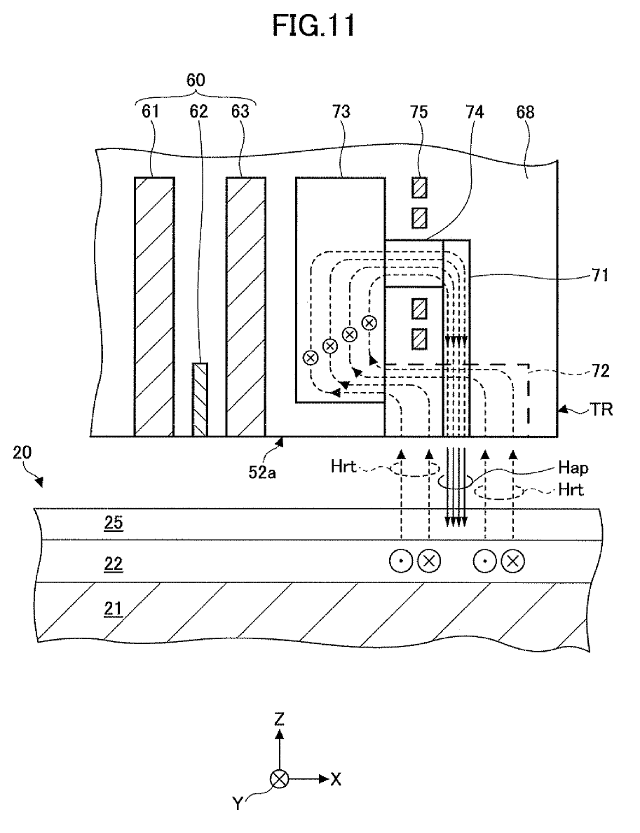

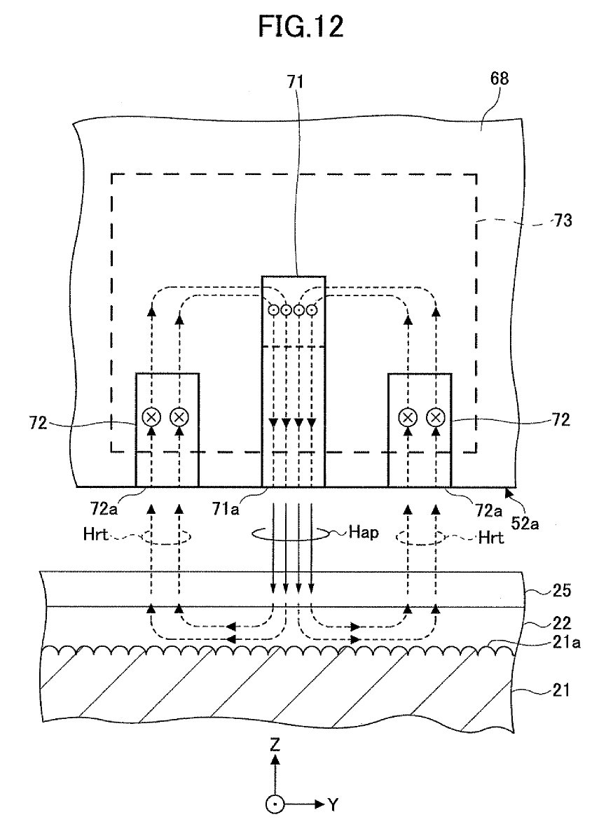

FIG. 10 is a diagram illustrating a structure of the medium opposing surface of the element part of the magnetic head, FIG. 11 is a cross sectional view illustrating the element part of the magnetic head and the perpendicular magnetic recording medium, and FIG. 12 is a cross sectional view illustrating the element part of the magnetic head and the perpendicular magnetic recording medium viewed from the air outlet end. In FIGS. 10 through 12, an X-axis direction indicates a direction from the air inlet end LD towards the air outlet end TR in FIG. 9, a Y-axis direction indicates a core width direction (width direction of the head slider 52) and a Z-axis direction indicates a depth direction from the medium opposing surface 52a of the head slider 52. Further, in FIGS. 11 and 12, the illustration of the structure of the perpendicular magnetic recording medium 20 is omitted in part, and only the substrate 21, the soft magnetic underlayer 22 and the recording layer 25 are illustrated for the sake of convenience.

As illustrated in FIGS. 10 through 12, the element part 55 includes a reproducing element 60 and a recording element 70. The reproducing element 60 includes two shields 61 and 63, and a magneto-resistive element 62 which is sandwiched between the shields 61 and 63 via a nonmagnetic insulator material 68 (for example, alumina layer). The magneto-resistive element 62 is an element which displays a magneto-resistive effect, such as the so-called Spin-Valve (SP) element or the ferromagnetic tunneling junction element. The magneto-resistive element 62 detects the signal magnetic field from the recording layer 25 of the perpendicular magnetic recording medium 20, and reads the information recorded in the recording layer 25. Other types of elements may be used in place of the magneto-resistive element 62 as long as the element can detect the signal magnetic field from the recording layer 25.

The recording element 70 includes a main magnetic pole 71 made of a soft magnetic material, a return yoke part, and a recording coil 75. The return yoke part includes side return yokes 72 made of a soft magnetic material, a lower yoke 73, and a back yoke 74.

As illustrated in FIG. 10, the main magnetic pole 71 and the side return yokes 72 are exposed at the medium opposing surface 52a. The main magnetic pole 71 has an end surface 71a with a trapezoidal shape having a side that is longer on the air outlet end than on the air inlet end. Thus, even if the skew (angle formed by circumferential direction of the perpendicular magnetic recording medium 20 and the direction from the air inlet end LD towards the air outlet end TR) of the magnetic head 50 increases from 0, it is possible to suppress the deviation in the width of the track that is magnetically formed in the recording layer 25 by the recording element 70.

In addition, in the medium opposing surface 52a, the side return yokes 72 are arranged in the Y-axis direction with respect to the main magnetic pole 71, that is, approximately in the radial direction of the perpendicular magnetic recording medium 20 when the magnetic head 50 floats from the perpendicular magnetic recording medium 20. As illustrated in FIG. 11, the side return yokes 72 extend in the X-axis direction, and make contact with the lower yoke 73. The lower yoke 73 is arranged from the medium opposing surface 52a in the depth direction via the nonmagnetic insulator material 68, and is not exposed at the medium opposing surface 52a. The back yoke 74 has one end making contact with the lower yoke 73, and another end making contact with the main magnetic pole 71. The recording coil 75 is wound around the back yoke 74 via the nonmagnetic insulator material 68, and the recording magnetic field is induced within the back yoke 74 when the recording current is applied to the recording coil 75.

The main magnetic pole 71, the side return yokes 72, the lower yoke 73 and the back yoke 74 are made of a soft magnetic material, such as NiFe (permalloy), CoZrNb, FeN, FeSiN, FeCo and CoNiFe.

Next, a description will be given of the flow of the magnetic flux due to the recording magnetic field at the time of the recording, by referring to FIGS. 11 and 12. The information is recorded in the recording layer 25 by switching the direction of the recording magnetic field between the direction outward from the main magnetic pole 71 and the direction inward to the main magnetic pole 71 on the medium opposing surface 52a, but a description will be given of the case where the recording magnetic field is generated in the direction outward from the main magnetic pole 71. In FIGS. 11 and 12, a symbol “X” surrounded by a circle “◯” indicates the magnetic flux flowing into the paper in the figures, while a symbol “·” surrounded by a circle “◯” indicates the magnetic flux flowing outwards from the paper in the figures.

When the recording current is applied to the recording coil 75, the magnetic flux is induced in the back yoke 74, and the induced magnetic flux flows within the main magnetic pole 71 and flows in the direction outward from the end surface 71a of the main magnetic pole 71, to thereby form the recording magnetic field. The recording magnetic field flows perpendicularly to the film surface of the recording layer 25 and reaches the soft magnetic underlayer 22. Because the side return yokes 72 are arranged on both sides of the main magnetic pole 71 in the radial direction, the magnetic flux flows to end surfaces 72a of the side return yokes 72 via the recording layer 25. The magnetic flux further returns from the side return yokes 72 to the back yoke 74 via the lower yoke 73. As described above, the magnetic flux flows in the radial direction within the soft magnetic underlayer 22 due to the arrangement of the side return yokes 72. But because the axes of easy magnetization of the soft magnetic underlayer 22 are oriented in the circumferential direction, the radial direction becomes the hard axis of magnetization and the high-frequency permeability becomes higher in the radial direction than in the circumferential direction. For this reason, the magnetic flux which switches at the high frequency more easily flows in the radial direction, and the spreading of the recording magnetic field in the in-plane direction of the recording layer 25 is suppressed. As a result, the WATER can be suppressed by the combination of the recording element 70 having the above described structure and the soft magnetic underlayer 22.

The reproducing element 60 and the recording element 70 of the magnetic head 50 may be formed by known methods. For example, the known methods may be a combination of film forming techniques such as sputtering, vacuum deposition and Chemical Vapor Deposition (CVD), and a patterning technique such as photolithography and dry etching.

As described above, according to the magnetic storage apparatus in this embodiment, the axes of easy magnetization of the soft magnetic underlayer are oriented in the circumferential direction, and the side return yokes of the recording element are arranged on both sides of the main magnetic pole in the radial direction at the medium opposing surface. Hence, the magnetic flux at the time of the recording more easily flows in the radial direction within the soft magnetic underlayer, and it becomes possible to suppress the generation of the spike noise and WATER.

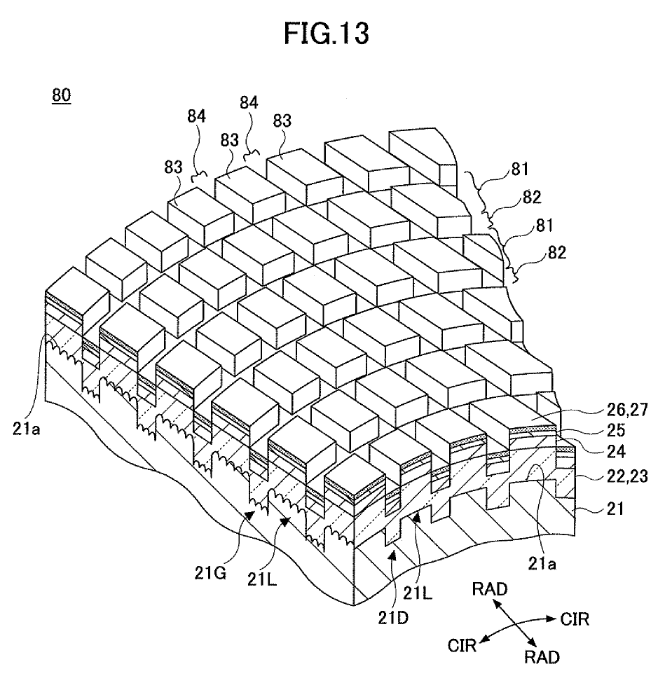

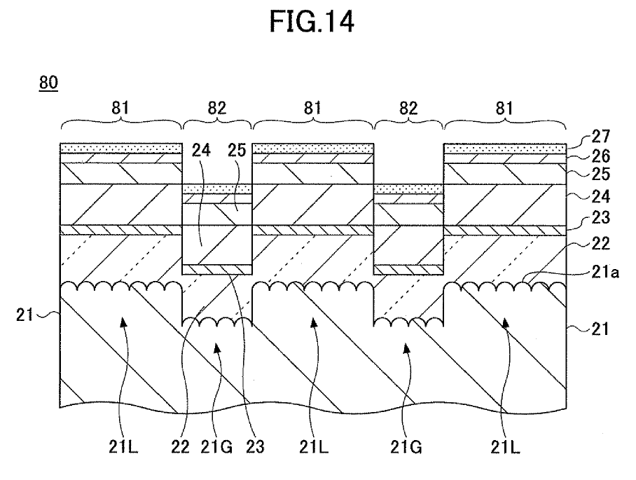

FIG. 13 is a perspective view illustrating another perpendicular magnetic recording medium in the embodiment, and FIG. 14 is a cross sectional view illustrating this other perpendicular magnetic recording medium illustrated in FIG. 13. FIG. 14 is the cross sectional view along the radial direction of the perpendicular magnetic recording medium illustrated in FIG. 13. In FIGS. 13 and 14, those parts that are the same as those corresponding parts described above are designated by the same reference numerals, and a description thereof will be omitted. In FIG. 13, the illustration of some of the layers is omitted for the sake of convenience.

As illustrated in FIGS. 13 and 14, a perpendicular magnetic recording medium 80 has track regions 81 which extend in the circumferential direction, and non-track region 82 which extend in the circumferential direction. Information is recorded in and reproduced from the track region 81. The non-track region 82 separates two mutually adjacent track regions 81. The track region 81 includes, along the circumferential direction, recording cells 83, and non-cell regions 84. The non-cell region 84 is provided on both sides of the cell region 83 along the circumferential direction. In other words, a plurality of recording cells 83, which are separated by the non-cell regions 84 along the circumferential direction by the non-cell regions 85, are formed in the track region 81.

The substrate 21 includes land regions 21L located at the positions of the track regions 81, and groove regions 21G located at the positions of the non-track regions 82. The land regions 21L (which are discontinuous in the circumferential direction) and the groove regions 21G are formed coaxially. A step or height difference between the land region 21L and the groove region 21G is set at least greater than the thickness of the recording layer 25. Because the adjacent track regions 81 are separated by the non-track region 82, the step or height difference set in the above described manner isolates the magnetic interaction between the adjacent track regions 81. In addition, the land regions 21L are mutually separated by concave parts 21D along the circumferential direction. The concave parts 21D have approximately the same depth as the groove regions 11G.

Similarly to the first embodiment, the texture 21a is formed on the surface of the substrate 21 along the circumferential direction (direction CIR). It is sufficient for the texture 21a to be formed only on the surface of the land regions 21L.

The structure provided on the substrate 21 having the surface configuration described above in the perpendicular magnetic recording medium 80 is similar to the structure of the first embodiment. In other words, the soft magnetic underlayer 22, the seed layer 23, the intermediate layer 24, the recording layer 25, the protection layer 26, and the lubricant layer 27 are successively deposited on the substrate 21 in the perpendicular magnetic recording medium 80.

The height of the recording cells 83 is higher than those of the non-cell regions 84 and the non-track regions 82, and the data is recorded in and reproduced from the recording layer 25 in the recording cells 83. Because the recording layer 25 of the recording cell 83 and the recording layer 25 of the adjacent recording cell 83 are separated, the magnetic interaction between the recording layers 25 of the adjacent recording cells 83 is weak, and the direction and magnitude of the magnetization in the recording layer 25 stabilize even at the high recording density. As a result, the SNR at the high recording density improves, to thereby enable further improvement in the recording density.

The size of the recording cell 83 may be appropriately selected depending on the linear recording density and the track density of the perpendicular magnetic recording medium 80. For example, in a case where the linear recording density (recording density in the circumferential direction) is 40 kbits/mm (1.0 Mbits/inch), the length (length in the circumferential direction) of the recording cell 83 is set to 20 nm, for example, and the length (separation of the recording cells 83 in the circumferential direction) of the non-cell region 84 is set to 5 nm, for example. From the point of view of isolating the magnetic interaction between the adjacent recording cells 83, the length of the non-cell region 84 is preferably set to 0.5 nm or greater. In the unit indicating the linear recording density, “bit” refers to a single magnetic flux transition.

In a case where the track density (track density in the radial direction) is 40 ktracks/mm (1.0 Mtracks/inch), the width (length in the radial direction) of the recording cell 83, that is, the width of the track region 81, is set to 20 nm, for example, and the width of the non-track region 82 is set to 5 nm, for example. By setting the widths of the track region 81 and the non-track region 82 in this manner, the linear recording density and the track density of the perpendicular magnetic recording medium 80 become 40 kbits/mm and 40 ktracks/mm, respectively, and the recording density per unit area becomes 1.6 Mbits/mm² (1 Tbits/inch²).

In addition, similarly as in the case of the perpendicular magnetic recording medium 20 illustrated in FIG. 2, the axes of easy magnetization of the soft magnetic underlayer 22 of the perpendicular magnetic recording medium 80 are oriented in the circumferential direction by the texture 21a. By the grooves of the texture 21a, the orientation of the axes of easy magnetization in the circumferential direction improves, to thereby increase the anisotropic field Hk. For this reason, the high-frequency permeability of the soft magnetic underlayer 22 in the circumferential direction improves, and it becomes possible to further reduce the WATER.

The method of forming the perpendicular magnetic recording medium 80 is approximately the same as the method of forming the perpendicular magnetic recording medium 20 illustrated in FIG. 2, and a detailed description thereof will be omitted. When forming the perpendicular magnetic recording medium 80, the texture 21a is formed by the ion beam irradiation, and thus, the texture 21a can easily be formed on the surface of the land regions 21L (convex parts) of the substrate 21 having the convex part and the concave parts. Therefore, it is preferable to form the texture 21a by the ion beam irradiation than by mechanical texturing.

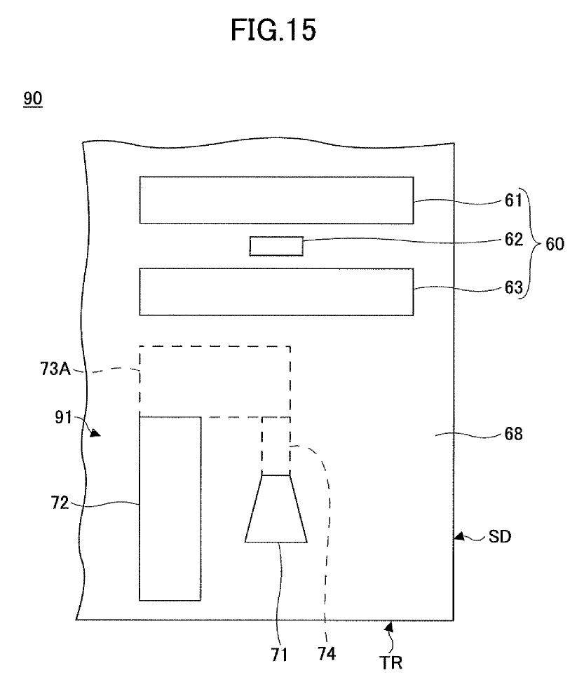

FIG. 15 is a diagram illustrating another structure of the element part of the magnetic head. In FIG. 15, those parts that are the same as those corresponding parts described above are designated by the same reference numerals, and a description thereof will be omitted.

As illustrated in FIG. 15, an element part 90 of the magnetic head is arranged at the air outlet end TR of the head slider away from the side part SD. The side return yoke 72 is provided on one end of the main magnetic pole 71 at the medium opposing surface, and the width of a lower yoke 73A is approximately one-half the width of the lower yoke 73 illustrated in FIG. 10. Otherwise, the element part 90 has a structure similar to that of the element part 55 illustrated in FIGS. 10 through 12, and the element 90 can obtain effects similar to those obtainable by the element part 55. Of course, the side return yoke 72 may be arranged at the air outlet end TR of the head slider closer to the side part SD. Furthermore, the element part 90 may be arranged at the central portion of the head slider in the width direction, similarly to the element part 55 illustrated in FIGS. 10 through 12.

Further, the present invention is not limited to these embodiments, but various variations and modifications may be made without departing from the scope of the present invention.

In the embodiments described above, the perpendicular magnetic recording medium is based on the disk-shaped substrate. However, a tape-shaped substrate may be used in place of the disk-shaped substrate, and for example, the present invention is also applicable to magnetic tapes using tape-shaped plastic film made of Poly-Ethylne-Telephthalate (PET), Poly-Ethylene-Naphthalate (PEN), polyimide and the like. In the case where the tape-shaped substrate is used, a “recording direction” corresponds to the “circumferential direction”, and a “direction perpendicular to the recording direction” corresponds to the “radial direction” of the disk-shaped substrate.

According to one aspect of the present invention, it is possible to provide a novel and useful magnetic storage apparatus having a perpendicular magnetic recording medium, capable of suppressing WATER.

All examples and conditional language recited herein are intended for pedagogical purposes to aid the reader in understanding the invention and the concepts contribute by the inventor to furthering the art, and are to be construed as being without limitation to such specifically recited examples and conditions, nor does the organization of such examples in the specification related to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A magnetic storage apparatus comprising:
a perpendicular magnetic recording medium having a disk-shaped substrate, a soft magnetic underlayer disposed on the substrate, and a recording layer disposed above the soft magnetic underlayer and having axes of easy magnetization perpendicular to a film surface thereof; and
a magnetic head having a medium opposing surface, and a recording element and a reproducing element which are exposed at the medium opposing surface,
wherein the soft magnetic underlayer has axes of easy magnetization oriented along a circumferential direction,
the recording element has a main magnetic pole part made of a soft magnetic material and applying a recording magnetic field, and a return yoke part made of a soft magnetic material and circulating the recording magnetic field, and
the return yoke part includes return side yokes arranged in a radial direction of the main magnetic pole part on the medium opposing surface,
whereby a magnetic flux of the recording magnetic field flows in the radial direction within the soft magnetic underlayer.

2. The magnetic storage apparatus as claimed in claim 1, wherein the substrate has a texture made up of a plurality of grooves extending in the circumferential direction on a surface thereof, and the soft magnetic underlayer is disposed in contact with the texture of the substrate.

3. The magnetic storage apparatus as claimed in claim 2, wherein the texture includes polishing impressions or marks that are mechanically formed and extend along the circumferential direction.

4. The magnetic storage apparatus as claimed in claim 2, wherein the grooves of the texture are defined by a plurality of protruding stripes which are elongated in the circumferential direction.

5. The magnetic storage apparatus as claimed in claim 4, wherein the texture is formed by irradiating an ion beam in a direction inclined with respect to the surface of the substrate along the radial direction.

6. The magnetic storage apparatus as claimed in claim 2, wherein:
the perpendicular magnetic recording medium further has a dielectric layer disposed between the substrate and the soft magnetic underlayer, and
the texture is formed on a surface of the dielectric layer in place of on the surface of the substrate.

7. The magnetic storage apparatus as claimed in claim 1, wherein:
the substrate has convex parts and concave parts extend alternately along the circumferential direction, and
the convex parts and the concave parts are alternately arranged alternately along the radial direction.

8. The magnetic storage apparatus as claimed in claim 7, wherein the texture is formed on surface of the projecting parts, and the soft magnetic underlayer is disposed in contact with the texture.

9. The magnetic storage apparatus as claimed in claim 8, wherein the texture includes polishing impressions or marks that are mechanically formed and extend along the circumferential direction.

10. The magnetic storage apparatus as claimed in claim 8, wherein the grooves of the texture are defined by a plurality of protruding stripes which are elongated in the circumferential direction.

11. The magnetic storage apparatus as claimed in claim 10, wherein the texture is formed by irradiating an ion beam in a direction inclined with respect to the surface of the substrate along the radial direction.

12. The magnetic storage apparatus as claimed in claim 7, wherein information is recorded in the recording layer above the convex parts.

13. The magnetic storage apparatus as claimed in claim 1, wherein the main magnetic pole part has an end surface with a trapezoidal shape having a side that is longer on an air outlet end than on an air inlet end on the medium opposing surface.

14. The magnetic storage apparatus as claimed in claim 1, wherein the return side yokes are arranged on both sides of the main magnetic pole in the radial direction on the medium opposing surface.
